(19) United States
(12) Patent Application Publication
(10) Pub. No.: US 2024/0230006 A9
(43) Pub. Date: Jul. 11, 2024

(54) PIPE PLUG

(71) Applicant: Pipe Storage Solutions, LLC, American Fork, UT (US)

(72) Inventors: Jason Plant, Cedar Hills, UT (US); R. Jason Barnes, Orem, UT (US)

(21) Appl. No.: 18/047,949

(22) Filed: Oct. 19, 2022

(51) Int. Cl. F16L 55/11

(52) U.S. Cl. CPC F16L 55/1141

(57) ABSTRACT

Pipe plugs can be used to minimize or eliminate contamination of pipes before they are installed. A pipe plug can include a body that is enclosed at a rear end and that forms a flange at a front end. The flange can be sized to cover an opening of a pipe in which the body of the pipe plug is inserted. The body can include fins that extend outwardly from an outer surface of the body to apply a retaining force against the pipe. One or more tabs can extend outwardly beyond the flange to facilitate removing the pipe plug from the pipe.

### CROSS-REFERENCE TO RELATED APPLICATIONS

N/A

### BACKGROUND

Municipalities, construction companies, and other entities oftentimes store pipes for significant amounts of time before they are installed. For example, a municipality could maintain a stock of PVC or ductile iron pipes to be used to install water lines. As represented in FIG. 1, pipes 100 are oftentimes stored in the open and on the ground where they can be contaminated such as by rain, dirt, leaves, animals, bugs, etc.

It is typically necessary to flush such pipes after they are installed to ensure that they are safe for delivering water to homes, businesses, or other locations. For example, governing regulations usually require that water flowing through the pipes meet minimum chlorination requirements. If the pipes are dirty or otherwise contaminated when they are installed, they may need to be flushed for a long time to meet such requirements. This can waste significant amounts of water and prolong the installation process.

### BRIEF SUMMARY

The present invention is directed to pipe plugs that can be used to minimize or eliminate contamination of pipes before they are installed. A pipe plug can include a body that is enclosed at a rear end and that forms a flange at a front end. The flange can be sized to cover an opening of a pipe in which the body of the pipe plug is inserted. The body can include fins that extend outwardly from an outer surface of the body to apply a retaining force against the pipe. One or more tabs can extend outwardly beyond the flange to facilitate removing the pipe plug from the pipe.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 provides an example of how pipes may be stored;

FIG. 2 provides an example of a pipe plug that is configured in accordance with embodiments of the present invention when the pipe plug is installed in a pipe;

FIG. 3A is a front perspective view of the pipe plug of FIG. 2;

FIG. 3B is a rear perspective view of the pipe plug of FIG. 2;

FIG. 3C is a front view of the pipe plug of FIG. 2;

FIG. 3D is a rear view of the pipe plug of FIG. 2;

FIG. 3E is a side view of the pipe plug of FIG. 2; and

FIG. 3F is a top view of the pipe plug of FIG. 2.

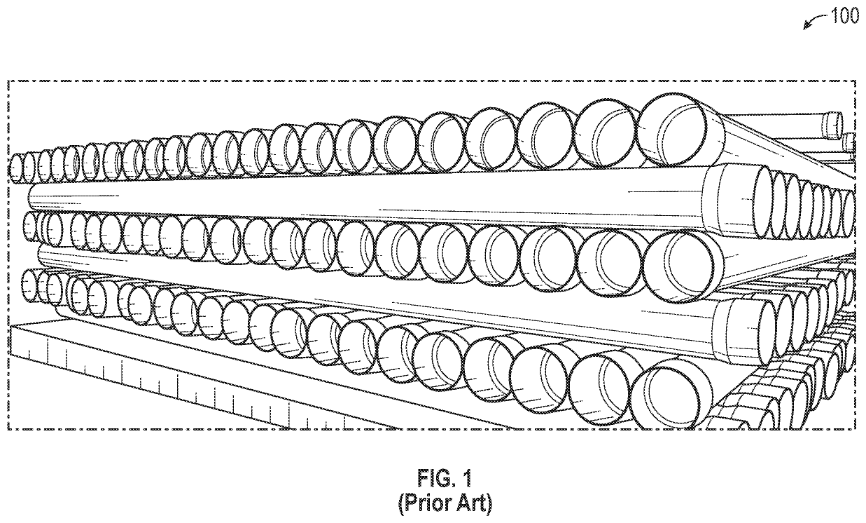

### DETAILED DESCRIPTION

Embodiments of the present invention are directed to pipe plugs that can be used to minimize or eliminate contamination of pipes before they are installed. These pipe plugs will be described in the context of pipes used to carry water. However, pipe plugs configured in accordance with embodiments of the present invention could be used with any type of pipe.

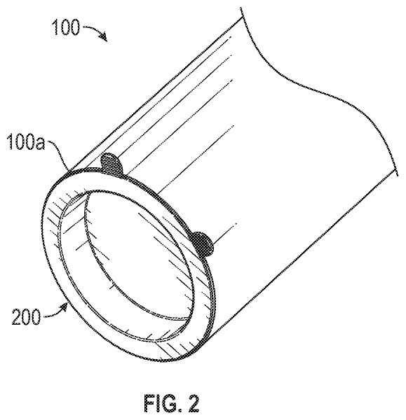

FIG. 2 provides an example of a pipe plug 200 that is configured in accordance with embodiments of the present invention when pipe plug 200 is installed in an opening 100a of pipe 100. As shown, pipe plug 200 can be shaped and sized to cover opening 100a to prevent dirt, leaves, animals, bugs, or other debris or objects from entering pipe 100.

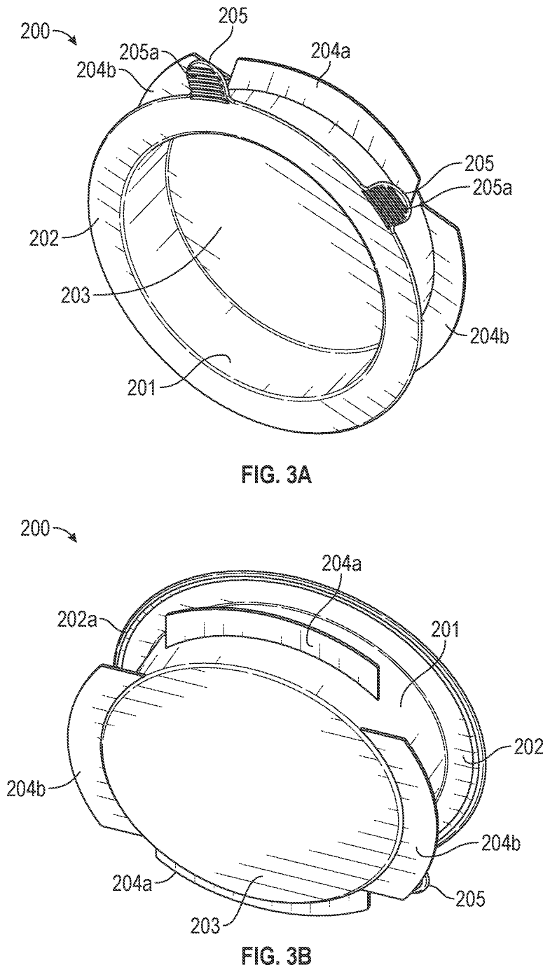

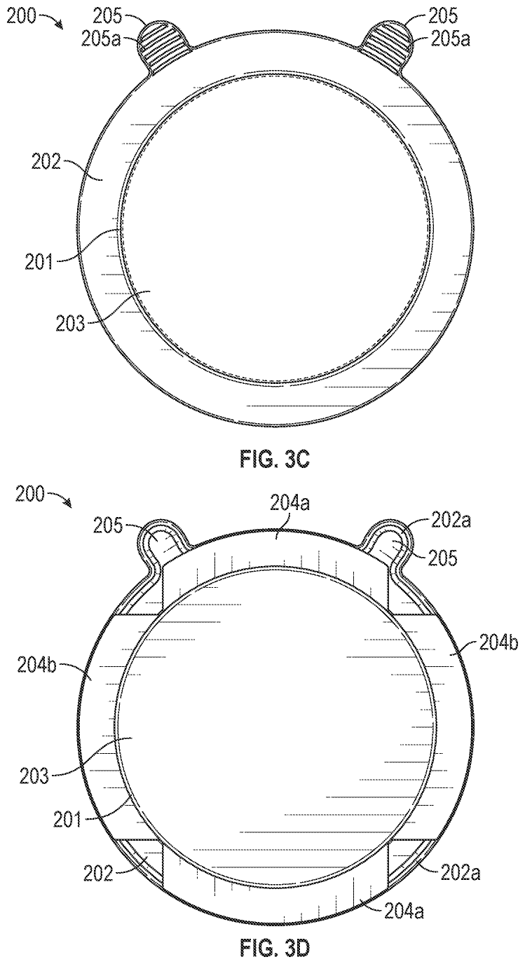

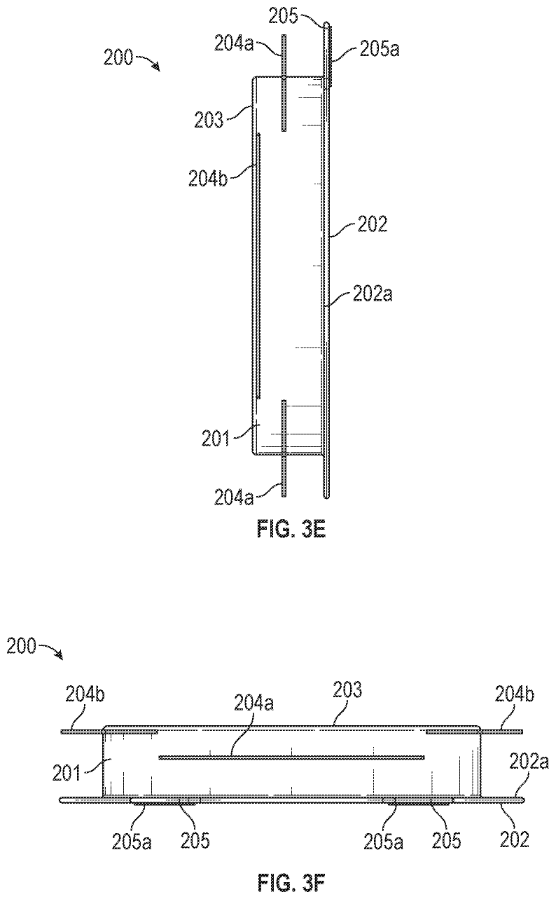

FIGS. 3A-3F provide different views of pipe plug 200 in isolation. Pipe plug 200 includes a body 201 that may have a cylindrical shape that is sized for insertion into pipe 100. A flange 202 may extend around a front end of body 201 and may have an outer diameter that generally matches (or may slightly exceed) the outer diameter of pipe 100 at opening 100a. A wall 203 may span and therefore enclose a rear end of body 201. Accordingly, when body 201 is inserted into opening 100a of pipe 100 to cause flange 202 to be positioned overtop and against opening 100a, flange 202 covers any gap between the outer surface of body 201 and the inner wall of pipe 100 and wall 203 creates a barrier to entry into pipe 100 through body 201.

In some embodiments, flange 202 may have a reinforced edge 202a. For example, reinforced edge 202a could be formed by increasing the thickness of flange 202 at its edge. Reinforced edge 202a can cause flange 202 to retain a flat shape and may assist in minimizing or eliminating any gap between flange 202 and opening 100a when pipe plug 200 is fully inserted into pipe 100.

Body 201 can include fins that are spaced around and extend outwardly from the outer surface of body 201. For example, in the depicted embodiments, a first pair of fins 204a extend from the top and bottom of body 201 and a second pair of fins 204b extend from opposing sides of body 201. In some embodiments, including the depicted embodiments, first pair of fins 204a and second pair of fins 204b may be offset from one another along the front-to-rear plane. For example, in the depicted embodiments, second pair of fins 204b are positioned at or towards rear 203 and first pair of fins 204a are spaced frontwardly from second pair of fins 204a.

As best seen in FIG. 3D, in some embodiments, each fin could have an outer diameter that substantially aligns with the outer diameter of flange 202. In embodiments where the outer diameter of flange 202 is designed to generally match the outer diameter of pipe 100, the outer diameter of the fins will cause them to pivot frontwardly (i.e., towards flange 202) when body 201 is inserted into opening 100a of pipe 100. Stated another way, the fins are too large to be inserted into opening 100a without flexing towards body 201. This pivoting/flexing of the fins will ensure that pipe plug 200 applies a strong retaining force on the inner wall of pipe 100 to prevent pipe plug 200 from being removed unintentionally.

The fins may also provide an added barrier to debris or bugs that may otherwise be able to pass between the inner wall of pipe 100 and body 201. For example, as best seen in FIG. 3D, adjacent fins may originate from a common angular point on body 201 so that the fins substantially surround body 201. In contrast, in some embodiments, the fins may be configured so that ends of adjacent fins overlap when viewed from a rear perspective.

A pipe plug configured in accordance with embodiments of the present invention could include any reasonable number of fins with any reasonable configuration and/or positioning of the fins relative to one another. For example, a pipe plug could include a single fin that extends fully around body 201, two fins that each extend around half of body 201, three fins that each extend around one third of body 201, etc. The fin(s) could be arranged in offset pairs or sets, in a stepped configuration, in a spiral configuration, in a random configuration, etc.

Pipe plug 200 may also include one or more tabs 205 that extend outwardly from or beyond the outer edge of flange 202. For example, in the depicted embodiments, pipe plug 200 includes two tabs 205 that are spaced relatively close together (e.g., approximately 70° apart). Tab 205 may be sized to facilitate gripping pipe plug 200 to remove it from pipe 100. In some embodiments, a front and/or rear surface of tabs 205 may include raised ridges 205a or other gripping texture. Tabs 205 could be oriented and/or spaced in any other suitable manner. For example, two tabs 205 could extend from opposing sides of flange 202, or more than two tabs 205 could be equally spaced around flange 202.

Returning to FIG. 2, with pipe plug 200 inserted into pipe 100, pipe 100 can be stored in the open and/or on the ground without concern that pipe 100 will become contaminated. For example, with pipe plug 200 fully inserted, flange 202 can contact opening 100a to block entry of any rain, debris, animal, bug, etc. Due to the force that the fins apply to the inner wall of pipe 100, it is unlikely that pipe plug 200 will unintentionally move outwardly from opening 100a thus minimizing any concern that pipe plug 200 may become loose or fall out. Furthermore, when it is time to install pipe 100, pipe plug 200 can be quickly and easily removed by pulling on tabs 205. By blocking contamination, pipe plug 200 can reduce the duration of flushing that must be performed on pipe 100 after installation.

In some embodiments, pipe plug 200 could be molded using a hard plastic and may be used with PVC pipes or ductile iron pipes that are used for water lines. However, pipe plug 200 could be formed of any suitable material and used with any type of pipe. Pipe plug 200 could also be formed in any desired size such as to match the outer diameter of a particular size of pipe 100 (e.g., between 3″ and 36″ inch diameters).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A pipe plug comprising:
a body that is configured to be inserted into an opening of a pipe;
a wall that encloses a rear end of the body;
a flange that extends from a front end of the body; and
one or more tabs that extend outwardly beyond the flange.

2. The pipe plug of claim 1, further comprising:
one or more fins that extend outwardly from the body.

3. The pipe plug of claim 2, wherein an outer diameter of the one or more fins matches an outer diameter of the flange.

4. The pipe plug of claim 2, wherein the one or more fins comprise multiple pairs of fins.

5. The pipe plug of claim 4, wherein the multiple pairs of fins comprise a first pair of fins that is positioned frontwards of a second pair of fins.

6. The pipe plug of claim 5, wherein the second pair of fins is positioned at the rear end of the body.

7. The pipe plug of claim 2, wherein the one or more fins are configured to pivot towards the body.

8. The pipe plug of claim 1, wherein the one or more tabs comprise two tabs.

9. The pipe plug of claim 1, wherein the one or more tabs comprise multiple tabs that are spaced less than 90 degrees from one another.

10. The pipe plug of claim 1, wherein the one or more tabs include a gripping texture.

11. The pipe plug of claim 1, wherein the one or more tabs extend outwardly from an outer edge of the flange.

12. The pipe plug of claim 1, wherein the flange has an outer diameter that matches an outer diameter of the pipe.

13. The pipe plug of claim 1, wherein the flange includes a reinforced edge.

14. The pipe plug of claim 1, wherein the body is cylindrical.

15. A pipe plug comprising:
a cylindrical body that is configured to be inserted into an opening of a pipe;
a wall that encloses a rear end of the cylindrical body;
a flange that extends around a front end of the cylindrical body;
one or more fins that extend outwardly from an outer surface of the cylindrical body; and
one or more tabs that extend outwardly from an outer edge of the flange.

16. The pipe plug of claim 15, wherein the one or more fins comprise a first pair of fins and a second pair of fins that is offset from the first pair of fins.

17. The pipe plug of claim 15, wherein the one or more tabs comprise two tabs.

18. The pipe plug of claim 15, wherein an outer diameter of the one or more fins matches an outer diameter of the flange.

19. A pipe plug comprising:
a body that is configured to be inserted into an opening of a pipe;
a wall that encloses a rear end of the body;
a flange that extends around a front end of the body;
a first pair of fins that extend outwardly from an outer surface of the body;
a second pair of fins that extend outwardly from the outer surface of the body; and
one or more tabs that extend outwardly from an outer edge of the flange.

20. The pipe plug of claim 19, wherein the first pair of fins are offset from the second set of fins.
